(19) United States
(12) Patent Application Publication
(10) Pub. No.: US 2008/0006377 A1
(43) Pub. Date: Jan. 10, 2008

(54) Stabilised Aluminosilicate Slurries

(75) Inventors: Simon Richard Stebbing, Warrington Cheshire (GB); Stephen George Ellison, Warrington Cheshire (GB); Alexis John Toft, Warrington Cheshire (GB)

Correspondence Address: DEMONT & BREYER, LLC, 100 COMMONS WAY, Ste. 250, HOLMDEL, NJ, 07733, US

(73) Assignee: INEOS SILICAS LIMITED, Warrington Cheshire WA5 1AB (GB)

(21) Appl. No.: 11/568,903

(22) PCT Filed: May 6, 2005
(86) PCT No.: PCT/GB05/01728

§ 371 Date: Jun. 26, 2007

(30) Foreign Application Priority Data
May 13, 2004 (GB) 0410697.7

(51) Int. Cl. C01B 39/02; C01B 39/14; C01B 39/22; C11D 3/12; D21H 17/68

(52) U.S. Cl. 162/102; 423/701

(57) ABSTRACT

An aqueous slurry comprises (a) a crystalline aluminosilicate represented by the empirical formula M_{2/n}O.Al₂O₃.xSiO₂.yH₂O wherein M represents a first metal moiety, said first metal having a valency of n, x is the molar ratio of silica to alumina and y indicates the molar ratio of water to alumina, (b) a mineral or organic acid, and (c) particulate silica. The silica may have a BET surface area greater than 500 m²/g and a pore volume, as measured by nitrogen manometry of less than 2.1 cm³/g. The slurry is stable on storage but has a low viscosity at low shear rate.

This invention relates to aqueous slurries of crystalline aluminosilicates and in particular to crystalline aluminosilicate slurries having controlled rheological properties.

Crystalline aluminosilicates, or zeolites, have found use as fillers in such applications as the manufacture of paper. For such use, it is convenient to transport the zeolite in bulk in the form of an aqueous slurry. Particularly useful aqueous zeolite slurries having a relatively low pH value and containing a multivalent salt in addition to the zeolite are described in PCT application published as WO 01/94512. These slurries are stable and do not settle on standing but, because they have a lightly gelled structure, they can sometimes be difficult to fully discharge fully from a vessel.

An object of this invention is to provide a modified version of such a slurry having a structure which is resistant to settling but is readily capable of being discharged from a vessel.

According to the invention, an aqueous slurry comprises
(a) a crystalline aluminosilicate represented by the empirical formula
   M_{2/n}O.Al₂O₃.xSiO₂.yH₂O

wherein M represents a first metal moiety, said first metal having a valency of n, x is the molar ratio of silica to alumina and y indicates the molar ratio of water to alumina,
(b) a mineral or organic acid, and
(c) particulate silica.

Generally, the silica has a BET surface area greater than 500 m²/g and a pore volume, as measured by nitrogen manometry of less than 2.1 cm³/g.

The above form of empirical formula is used for simplicity in expressing the molar ratios of the components, but it can be seen that the ratio of Si atoms to Al atoms in this formula is equal to x/2 and the ratio of water molecules to Al atoms is equal to y/2.

The first metal M can be any metal capable of forming a crystalline aluminosilicate structure having the above empirical formula. Preferably, M is an alkali metal and the preferred alkali metal is sodium.

The crystalline aluminosilicates used in the invention are usually known as zeolites and can have the structure of any of the known zeolites. The structure and characteristics of many zeolites are described in the standard work “Zeolite Molecular Sieves” by Donald W. Breck, published by Robert E. Krieger Publishing Company. Usually, the value of x in the above empirical formula is in the range 1.5 to 10. The value of y, which represents the amount of water contained in the voids of the zeolite, can vary widely. In anhydrous material y=0 and, in fully hydrated zeolites, y is typically up to 5.

Zeolites useful in this invention may be based on naturally-occurring or synthetic aluminosilicates and the preferred forms of zeolite have the structure known as zeolite P, zeolite X or zeolite A. Particularly preferred forms of zeolite are those disclosed in EP-A-0 384 070, EP-A-0 565 364, EP-A-0 697 010, EP-A-0 742 780, WO-A-96/14270, WO-A-96/34828 and WO-A-97/06102, the entire contents of which are incorporated herein by this reference. The zeolite P described in EP-A-0 384 070 has the empirical formula given above in which M represents an alkali metal and x has a value up to 2.66, preferably in the range 1.8 to 2.66, and has a structure which is particularly useful in the present invention.

Slurries useful in the paper industry preferably have an approximately neutral pH. Particularly useful slurries of this invention contain an amount of the mineral or organic acid which is sufficient to produce a slurry having a pH in the range 6 to 9, preferably in the range 7 to 9.

The particle size of the crystalline aluminosilicates used in the slurries of this invention is adjusted to suit the intended use. Typically, the volume average particle size will be greater than 0.1 μm and, usually, less than 20 μm. More preferably, the crystalline aluminosilicates will have a volume average particle size in the range 0.5 to 10 μm. For use as a filler for papers, the crystalline aluminosilicate preferably has a volume average particle size in the range 1 to 5 μm.

Various methods of assessing particle size are known and all give slightly different results. In the present invention, a size distribution is obtained by light scattering from particles dispersed by ultrasound in demineralised water using a Malvern Mastersizer®. The volume average particle size is the average particle size at 50 percent cumulative volume as determined from the distribution.

The amount of crystalline aluminosilicate, expressed as dry weight of aluminosilicate present in the slurry is usually above 20 percent by weight and often above 30 percent by weight. The upper practical limit on the amount of aluminosilicate in the slurry will depend upon the viscosity of the slurry, which is likely to be too high for use in many applications when more than 65 percent dry weight of aluminosilicate is present. Preferably, the amount of crystalline aluminosilicate, expressed as dry weight of aluminosilicate present in the slurry, is in the range 43 to 60 percent by weight, more preferably 43 to 55 percent by weight, most preferably 43 to 52 percent by weight. For the purposes of this invention dry aluminosilicate is considered to be aluminosilicate which has been heated at 105° C. to constant weight.

Examples of suitable mineral acids include sulphuric acid, hydrochloric acid and nitric acid. An example of a suitable organic acid is acetic acid.

The slurry can also contain silica having a BET surface area greater than 500 m²/g. Preferably the silica has a BET surface area greater than 550 m²/g, more preferably greater than 600 m²/g. Usually the surface area is less than 1200 m²/g.

The silica can also have a pore volume as measured by nitrogen manometry of less than 2.1 cm³/g. Preferably, the pore volume is less than 1.2 cm³/g, more preferably the pore volume is less than 0.5 cm³/g.

Preferably, the silica is silica gel or a precipitated silica.

The silica preferably has a volume average particle size in the range 0.5 to 30 μm, as measured by Malvern Mastersizer®. More preferably, the volume average particle size of the silica is in the range 2 to 15 μm.

The silica is preferably present in the slurry in an amount in the range 0.2 to 40 percent by weight with respect to the dry weight of crystalline aluminosilicate. More preferably, the amount of silica present is in the range 0.5 to 15 percent by weight with respect to dry weight of crystalline aluminosilicate and frequently, the amount of silica used is in the range 0.2 to 5.0 percent by weight with respect to dry weight of crystalline aluminosilicate.

The crystalline aluminosilicate used in the invention can be prepared by a conventional process. For example, a zeolite of type A can be prepared by mixing together sodium aluminate and sodium silicate at a temperature within the range of ambient temperature up to boiling point to form a gel, ageing the gel with stirring at a temperature usually in the range 70 to 95° C., separating the crystalline sodium aluminosilicate thus formed, washing, generally at a pH in the range 10 to 12.5, and drying. Zeolite of type P can be prepared by a similar process but zeolite type P formation is induced by the addition of type P seeds to the mixture of sodium aluminate and sodium silicate.

According to another aspect of the invention there is provided the use, in the manufacture of paper, of an aqueous slurry comprising
(a) a crystalline aluminosilicate represented by the empirical formula
   M_{2/n}O.Al₂O₃.xSiO₂.yH₂O

wherein M represents a first metal moiety, said first metal having a valency of n, x is the molar ratio of silica to alumina and y indicates the molar ratio of water to alumina,
(b) a mineral or organic acid, and
(c) particulate silica.

The slurry of the invention can be prepared in a number of ways. The crystalline aluminosilicate, mineral or organic acid and water can be mixed in any order. Therefore, according to yet another aspect of the invention there is provided a method of making an aqueous slurry comprising mixing
(a) a crystalline aluminosilicate represented by the empirical formula
   M_{2/n}O.Al₂O₃.xSiO₂.yH₂O

wherein M represents a first metal moiety, said first metal having a valency of n, x is the molar ratio of silica to alumina and y indicates the molar ratio of water to alumina,
(b) a mineral or organic acid,
(c) particulate silica, and
(d) water

together to produce a slurry. A preferred method, however, comprises forming a precursor slurry containing the acid and the crystalline aluminosilicate and subsequently adding the silica.

The following tests have been used in this invention.

BET Surface Area and Pore Volume

Surface area of the silicas were measured using standard nitrogen adsorption methods of Brunauer, Emmett and Teller (BET) using a multi-point method with an ASAP 2400 apparatus supplied by Micromeritics of USA. The method is consistent with the paper by S. Brunauer, P. H. Emmett and E. Teller, J. Am. Chem. Soc., 60, 309 (1938). The pore volume was determined by a single point method as described in the operation manual for the ASAP 2400 apparatus. Samples are outgassed under vacuum at 270° C. for 1 hour before measurement at about −196° C.

Volume Average Particle Size

The volume average particle size of the silica is determined using a Malvern Mastersizer® model S, with a 300 RF lens and MS17 sample presentation unit. This instrument, made by Malvern Instruments, Malvern, Worcestershire uses the principle of Fraunhofer diffraction, utilising a low power He/Ne laser. Before measurement the sample is dispersed ultrasonically at 25 W ultrasound power in demineralised water for 5 minutes to form an aqueous suspension. The Malvern Mastersizer® measures the volume particle size distribution of the silica. The volume average particle size (d₅₀) or 50 percentile is easily obtained from the data generated by the instrument. Other percentiles, such as the 90 percentile (d₉₀), are readily obtained.

The invention is illustrated by the following non-limiting examples.

### EXAMPLE

Three slurries were prepared with the compositions given in Table 1 below.

TABLE 1

| | Sample | | |
|---|---|---|---|
| | A | B | C |
| Demineralised Water/wt. % | 47.8 | 49.3 | 48.6 |
| Al₂(SO₄)₃•14 H₂O/wt % | 1.5 | 0 | 0 |
| Zeolite A24 (water content 7.03% | 50 | 50 | 50 |
| by drying at 105° C.)/wt. % | | | |
| Silica/wt. % | 0.7 | 0 | 0.7 |
| Sulphuric acid (100%)/wt. % | 0 | 0.7 | 0.7 |
| Sample size/g | 1000 | 200 | 250 |
| pH | 7.64 | 8.12 | 8.05 |
| Dry solids (loss at 105)/wt. % | | 46.6 | 48.6 |
| Brookfield viscosity at 20 rpm/cps | 3850 | 3700 | 955 |
| | (spindle 4) | (spindle 5) | (spindle 3) |
| Mettler viscosity at 20 sec − 1/Pa s | 0.819 | 0.609 | 0.284 |

The amounts given above are parts by weight.

Zeolite A24 is a P type zeolite sold by INEOS Silicas Limited under the trade mark Doucil A24. It had a volume average particle size as measured by Malvern Mastersizer® of 1.5 μm.

The silica was a silica gel sold by INEOS Silicas Limited under the Trade Name Sorbosil AC30. It had a volume average particle size of 7.9 μm, a pore volume to nitrogen of 0.39 cm³g⁻¹ and BET surface area of 725 m²g⁻¹.

Sulphuric acid was received at 40 weight percent and diluted with demineralised water to 10 weight percent before being added to the mixtures. The amount of acid added is expressed at 100 weight percent in Table 1.

The rheological properties of the slurries were determined immediately after the slurries were prepared using a Mettler Toledo RM 180 Rheomat rheometer, at 22±1° C., with a Mooney cup and bob geometry. The samples were shaken by hand prior to measurement but were not sheared vigorously. The rheometer programme consisted of shearing the sample at a set shear rate for 30 seconds, after which a shear stress measurement was taken at that shear rate. Measurements were taken at 10, 20, 30, 40, 60, 100, 200, 350 and 500 s⁻¹. The Brookfield viscosity measurements were also carried out at 22±1° C., with the viscosity being recorded after 1 minute of shearing at 20 rpm. The spindle chosen for each sample is indicated in Table 1.

1. An aqueous slurry comprising:
(a) a crystalline aluminosilicate represented by the empirical formula
M_{2/n}O.Al₂O₃.xSiO₂.yH₂O
wherein M represents a first metal moiety, said first metal having a valency of n, x is the molar ratio of silica to alumina, and y indicates the molar ratio of water to alumina;
(b) one of (i) a mineral acid and (ii) an organic acid; and
(c) particulate silica with a BET surface area greater than 500 m²/g and a pore volume, as measured by nitrogen manometry of less than 2.1 cm³/g.

2. An aqueous slurry according to claim 1 characterised in that M is sodium.

3. An aqueous slurry according to claim 1 characterised in that the crystalline aluminosilicate is one of a zeolite P, zeolite A, and zeolite X.

4. An aqueous slurry according to claim 1 in which the acid is sulphuric acid.

5. An aqueous slurry according to claim 1 characterised in that it has a pH in the range 6 to 9.

6. An aqueous slurry according to claim 1 characterised in that the crystalline aluminosilicate has a volume average particle size in the range 0.1 to 20 μm.

7. An aqueous slurry according to claim 1 characterised in that the amount of crystalline aluminosilicate present in the slurry is in the range 43 to 60 percent by weight calculated as dry aluminosilicate.

8. An aqueous slurry according claim 1 in which the silica has a BET surface area greater than 550 m²/g.

9. An aqueous slurry according to claim 1 characterised in that the silica has a pore volume of less than 1.2 cm³/g.

10. An aqueous slurry according to claim 1 characterised in that the silica has a volume average particle size in the range 0.5 to 30 μm.

11. An aqueous slurry according to any claim 1 characterised in that the amount of silica present in the slurry is in the range 0.2 to 40 percent by weight with respect to dry weight of crystalline aluminosilicate present.

12-14. (canceled)

15. An aqueous slurry according to claim 7 characterised in that the amount of crystalline aluminosilicate present in the slurry is in the range 43 to 55 percent by weight calculated as dry aluminosilicate.

16. An aqueous slurry according to claim 15 characterised in that the amount of crystalline aluminosilicate present in the slurry is in the range 43 to 52 percent by weight calculated as dry aluminosilicate.

17. An aqueous slurry according claim 8 in which the silica has a BET surface area greater than 600 m²/g.

18. An aqueous slurry according claim 9 characterised in that the silica has a pore volume of less than 0.5 cm³/g.

19. A method for manufacturing paper comprising using an aqueous slurry that comprises:
(a) a crystalline aluminosilicate represented by the empirical formula
M_{2/n}O.Al₂O₃.xSiO₂.yH₂O
wherein M represents a first metal moiety, said first metal having a valency of n, x is the molar ratio of silica to alumina, and y indicates the molar ratio of water to alumina;
(b) one of (i) a mineral acid and (ii) an organic acid; and
(c) particulate silica with a BET surface area greater than 500 m²/g and a pore volume, as measured by nitrogen manometry of less than 2.1 cm³/g.

20. A method of making an aqueous slurry comprising mixing
(a) a crystalline aluminosilicate represented by the empirical formula
M_{2/n}O.Al₂O₃.xSiO₂.yH₂O
wherein M represents a first metal moiety, said first metal having a valency of n, x is the molar ratio of silica to alumina, and y indicates the molar ratio of water to alumina,
(b) one of (i) a mineral acid and (ii) an organic acid,
(c) particulate silica with a BET surface area greater than 500 m²/g and a pore volume, as measured by nitrogen manometry of less than 2.1 cm³/g, and
(d) water together to produce a slurry.

21. A method according to claim 20 in which the water, aluminosilicate and acid are mixed to form a precursor slurry, and the silica is added to the precursor slurry.
